(19) United States
(12) Patent Application Publication
(10) Pub. No.: US 2022/0286817 A1
(43) Pub. Date: Sep. 8, 2022

(54) DISTRIBUTED DATA CACHING FOR HIGHER RATE OF SAVINGS AND CUSTOMER BUY-IN

(71) Applicant: Capital One Services, LLC, McLean, VA (US)

(72) Inventors: Steven DANG, Plano, TX (US); Chih-Hsiang CHOW, Plano, TX (US); Elizabeth FURLAN, Plano, TX (US)

(73) Assignee: Capital One Services, LLC, McLean, VA (US)

(21) Appl. No.: 17/189,325

(22) Filed: Mar. 2, 2021

(51) Int. Cl. H04W 4/06; H04W 4/029; H04W 4/021

(52) U.S. Cl. CPC H04W 4/06; H04W 4/029; H04W 4/021

(57) ABSTRACT

Embodiments disclosed are directed to a system that performs steps to monitor a geographic area to detect a triggering event. The triggering event can inform the system that there is a data transmission problem scenario within the geographic area. The triggering event can cause a distributor node to distribute data to one or more devices within the geographic area. The system can select the distributor node by determining whether a projected travel path of a node will overlap with the geographic area. The system can further determine whether the distributor node has entered the geographic area, and activate the distributor node to distribute data to the one or more devices within the geographic area.

### TECHNICAL FIELD

Embodiments relate to a system for data distribution, specifically a system for peer-to-peer data distribution.

### BACKGROUND

From time to time, devices within geographic areas may not be able to receive data. There are a variety of reasons for this. For example, certain geographic areas may suffer from weak or non-existent telecommunication signals covering or reaching those geographic areas. This may be because there is a lack of telecommunication infrastructure in the geographic area (resulting in dead zones). Dead zones may also arise from faulty telecommunication infrastructure (e.g., downed transmitters, antennas, base stations, etc.).

Sometimes, the problem may not be due to the telecommunication infrastructure, but rather from server side problems. For example, companies attempting to transmit data to certain geographic areas may not be able to do so due to a large number of devices within the geographic area making data requests. The data requests may overwhelm the company servers, resulting in slow data transmission rates.

Natural or man-made disasters can also affect the ability of devices to receive data in geographic areas. These can include hurricanes, tornados, floods, earthquakes, fires, etc. that can damage or destroy telecommunication infrastructure and/or interfere with data transmissions.

The aforementioned scenarios (collectively referred to as “data transmission problem scenarios” or individually referred to as a “data transmission problem scenario”) are particularly problematic when third-parties, such as companies, institutions, governmental authorities, etc., want to push data to devices within these geographic areas. Thus, systems and methods are needed to improve the ability to distribute data to devices in geographic areas affected by data transmission problem scenarios.

### SUMMARY

Embodiments disclosed herein provide systems and methods for data distribution. The systems and methods improve conventional systems by proactively detecting data transmission problem scenarios and reactively activing distributor nodes to distribute data to other devices in geographic areas affected by data transmission problem scenarios. As a result, devices within geographic regions that would not be able to obtain data can receive data. In embodiments, the systems can perform methods to monitor a geographic area to detect a triggering event. In embodiments, the triggering event can indicate data transmission problem scenarios. In embodiments, the triggering event can cause a distributor node to distribute data to one or more devices within the geographic area. In embodiments, the systems can determine whether a node from a plurality of nodes is approaching the geographic area based on analyzing a travel vector and a travel radius of the node. In embodiments, the systems can determine a projected travel path and whether the projected travel path will overlap with the geographic area. In embodiments, the systems can select the node as the distributor node. In embodiments, the system can determine whether the distributor node has entered the geographic area. In embodiments, the systems can activate, based on the determining the distributor node has entered the geographic area, the distributor node to distribute data to the one or more devices within the geographic area.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the art to make and use the embodiments.

FIG. 1 is an example system for distributing data according to embodiments.

FIG. 2 is an example control flow for the system according to embodiments.

FIG. 3 is an example method of operating the system according to embodiments.

FIG. 4 is an example architecture of the devices implementing the system according to embodiments.

### DETAILED DESCRIPTION

Embodiments disclosed herein relate to a system that performs steps for distribution of data in geographic areas affected by data transmission problem scenarios. The system actively monitors geographic areas to identify data transmission problem scenarios. Based on identifying a data transmission problem scenario, the system reactively identifies potential nodes to act as distributor nodes of data within the affected geographic area. The distributor nodes are activated to distribute data to other devices within the geographic area. The distributor nodes do this through the use of peer-to-peer data distribution schemes.

Embodiments disclosed herein allow the aforementioned functionality by disclosing a system to perform steps to monitor a geographic area to detect a triggering event. The triggering event can inform the system that there is a data transmission problem scenario within the geographic area. The triggering event can cause a distributor node to distribute data to one or more devices within the geographic area. The system can select the distributor node by determining whether a node from a plurality of nodes is approaching the geographic area. The determining may be based on analyzing a travel vector and a travel radius of the node to determine a projected travel path. The system can determine whether the projected travel path will overlap with the geographic area. The system can select, based on the determining, a node as the distributor node. The system can further determine whether the distributor node has entered the geographic area and activate the distributor node to distribute data to the one or more devices within the geographic area.

The following embodiments are described in sufficient detail to enable those skilled in the art to make and use the disclosure. It is to be understood that other embodiments are evident based on the present disclosure, and that system, process, or mechanical changes may be made without departing from the scope of embodiments of the present disclosure.

In the following description, numerous specific details are given to provide a thorough understanding of the disclosure. However, it will be apparent that the disclosure may be practiced without these specific details. In order to avoid obscuring an embodiment of the present disclosure, some well-known circuits, system configurations, architectures, and process steps are not disclosed in detail.

The drawings showing embodiments of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the disclosure may be operated in any orientation.

The term “module” or “unit” referred to herein may include software, hardware, or a combination thereof in an embodiment of the present disclosure in accordance with the context in which the term is used. For example, the software may be machine code, firmware, embedded code, or application software. Also, for example, the hardware may be circuitry, a processor, a special purpose computer, an integrated circuit, integrated circuit cores, or a combination thereof. Further, if a module or unit is written in the system or apparatus claim section below, the module or unit is deemed to include hardware circuitry for the purposes and the scope of the system or apparatus claims.

The term “service” or “services” referred to herein can include a collection of modules or units. A collection of modules or units may be arranged, for example, in software or hardware libraries or development kits in an embodiment of the present disclosure in accordance with the context in which the term is used. For example, the software or hardware libraries and development kits may be a suite of data and programming code, for example pre-written code, classes, routines, procedures, scripts, configuration data, or a combination thereof, that may be called directly or through an application programming interface (API) to facilitate the execution of functions of the system.

The modules, units, or services in the following description of the embodiments may be coupled to one another as described or as shown. The coupling may be direct or indirect, without or with intervening items between coupled modules, units, or services. The coupling may be by physical contact or by communication between modules, units, or services.

### System Overview and Function

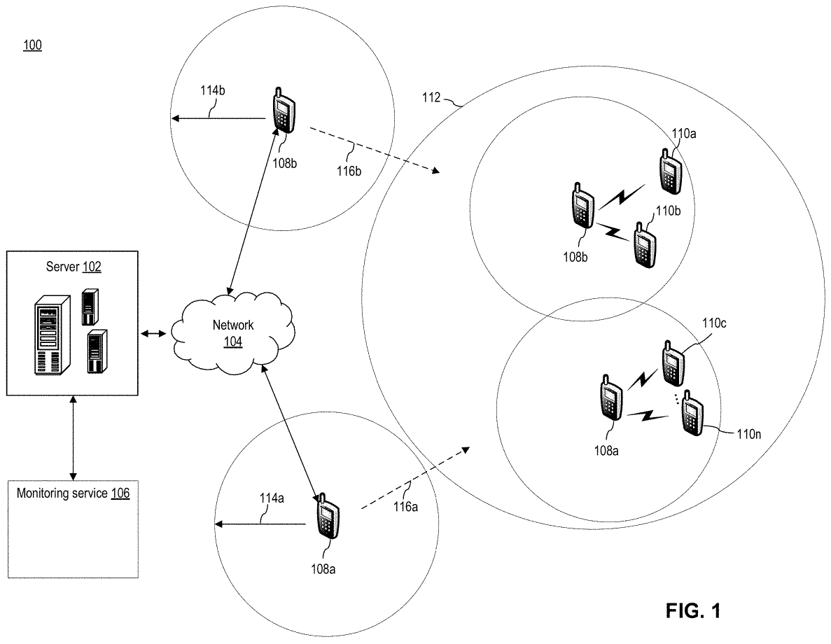

FIG. 1 is an example system 100 according to embodiments. In several embodiments, system 100 may be used for distributing data in a geographic area 112 affected by data transmission problem scenarios. In several embodiments, the system 100 can comprise, without limitation, a server 102, distributor nodes 108, and one or more devices 110. In several embodiments, the one or more devices 110 can receive data from storage or cache of the distributor nodes 108. In FIG. 1, the distributor nodes are shown as {108a, 108b}. The one or more devices 110 are shown as {110a, 110b, 110c, . . . 110n}. While not shown in FIG. 1, in some embodiments, other devices may also be used in system 100.

In several embodiments, the server 102 may couple to the distributor nodes 108, via a network 104, to distribute data to the one or more devices 110 within the geographic area 112. The geographic area 112 can refer to an area of land that may be considered as a unit for the purposes of some geographical classification. The geographic area 112 may be, for example and without limitation, a city, a town, a municipality, a county, a region, sections within a city, sections within a town, sections within a municipality, etc. In several embodiments, the server 102 can activate (e.g. command) the distributor nodes 108 to distribute data to the one or more devices 110 within the geographic area 112. The activation can occur if the server 102 determines that the geographic area 112 is affected by data transmission problem scenarios. How the server 102 makes the determination will be discussed further below.

In several embodiments, the server 102 may be part of a backend computing infrastructure, including a server infrastructure of a company, institution, or governmental agency. While the server 102 is shown in FIG. 1 as a single component, this is merely exemplary. In several embodiments, the server 102 can comprise a variety of centralized or decentralized computing devices. For example, the server 102 may include a mobile device, a laptop computer, a desktop computer, grid-computing resources, a virtualized computing resource, cloud computing resources, peer-to-peer distributed computing devices, a server farm, or a combination thereof. The server 102 may be centralized in a single room, distributed across different rooms, distributed across different geographic locations, or embedded within the network 104. While the server 102 can couple with the network 104 to communicate with the distributor nodes 108, the server 102 can also function as a stand-alone device separate from the distributor nodes 108. Stand-alone refers to a device being able to work and operate independently of other devices.

In several embodiments, if the server 102 is implemented using cloud computing resources, the cloud computing resources may be resources of a public or private cloud. Examples of a public cloud include, without limitation, Amazon Web Services (AWS)™, IBM Cloud™, Oracle Cloud Solutions™, Microsoft Azure Cloud™, and Google Cloud™. A private cloud refers to a cloud environment similar to a public cloud with the exception that it is operated solely for a single organization.

In several embodiments, the server 102 can monitor the geographic area 112 to determine whether the geographic area 112 is, or may be, affected by data transmission problem scenarios. The server 102 can do this in a variety of ways. In several embodiments, to make the determination, the server 102 can utilize a monitoring service 106. In several embodiments, the monitoring service 106 can detect the state of telecommunication signals of the geographic area 112. In several embodiments, the monitoring service 106 may be a third-party service, for example and without limitation, Down Detector™, ThousandEyes™, or a similar service. The monitoring service 106 can indicate whether the geographic area 112 is a telecommunication dead zone (e.g., has a weak or non-existent telecommunication signal covering or reaching the geographic area 112). In several embodiments, the server 102 can couple to the monitoring service 106, via an API or otherwise, to obtain data regarding whether the geographic area 112 is a telecommunication dead zone.

In several embodiments, the server 102 can also make the determination by monitoring the geographic area 112 to determine whether characteristics of the geographic area 112 indicate that data transmission problem scenarios affect it. In several embodiments, the characteristics may be indicated by a triggering event. The triggering event refers to an incident that occurs indicating the geographic area 112 is, or may be, affected by data transmission problem scenarios.

In several embodiments, the triggering event can include, for example and without limitation, a number of the one or more devices 110 within the geographic area 112 being equal to or greater than a threshold value. In several embodiments, if it is known that if the number of the one or more devices 110 within the geographic area 112 is equal to or greater than the threshold value, telecommunication infrastructure or servers attempting to push data to the one or more devices 110 in the geographic area 112 can become overwhelmed. In several embodiments, the server 102 can determine that the geographic area 112 is, or may be, affected by a data transmission problem scenario by becoming overwhelmed.

In several embodiments, the triggering event can also include an increase or decrease of data requests from the one or more devices 110 in the geographic area 112. For example, if the increase or decrease deviates from a historic average of data requests for the geographic area 112, the deviation can indicate a data transmission problem scenario.

In several embodiments, the server can determine if the increase or decrease of data requests indicate a data transmission problem scenario, by comparing a current volume of data requests in the geographic area 112 to a historic average of data requests for the geographic area 112. For example, if data requests are typically “X” number of requests, and the server 102 detects that data requests have decreased by ninety percent, the server 102 can determine that the geographic area 112 may be affected by a data transmission problem scenario. Also for example, if data requests increase by ninety percent, and it is known that the increased volume of data cannot be handled by the telecommunication infrastructure or servers pushing the data to the geographic area 112, the server 102 can determine that the geographic area 112 may be affected by a data transmission problem scenario.

In several embodiments, based on determining that the geographic area 112 is, or may be, affected by a data transmission problem scenario, the server 102 may select and activate the distributor nodes 108 approaching the geographic area 112 to distribute data to the one or more devices 110 within the geographic area 112.

In several embodiments, the server 102 may further transmit data to the distributor nodes 108 to distribute to the one or more devices 110. How the server 102 selects and activates the distributor nodes 108 will be discussed further below.

In several embodiments, the distributor nodes 108 may be pre-selected. For example, in several embodiments, the pre-selection can comprise having users to which the distributor nodes 108 belong to, opt-into a cooperative data-sharing program of the company, institution, or governmental agency deploying the system 100, to allow the user's devices to become the distributor nodes 108. In several embodiments, the distributor nodes 108 can further be selected based on determining a projected travel path. How the projected travel path is determined will be discussed further below.

In several embodiments, the distributor nodes 108 may be any of a variety of centralized or decentralized computing devices. For example, and without limitation, the distributor nodes 108 may be a mobile device, a laptop computer, or a desktop computer. The distributor nodes 108 can also function as stand-alone devices separate from other devices of the system 100. In several embodiments, each distributor node of the distributor nodes 108 can have an associated travel radius 114 and travel vector 116.

In several embodiments, the travel radius 114 refers to a radius associated with each of the distributor nodes 108. In FIG. 1, the travel radius 114 of each of the distributor nodes 108 is shown as {114a, 114b}. In several embodiments, the travel radius 114 can correlate to, or be equivalent to, a distance that each of the distributor nodes 108 can transmit a telecommunication signal. For example, if the distributor nodes 108 are mobile devices (e.g., mobile phones), each may be able to transmit its own telecommunication signal (e.g., a Bluetooth signal, a near field communication (NFC) signal, a WiFi signal, etc.) to a maximum radius. In several embodiments, the travel radius 114 can equal the maximum radius. In several embodiments, the travel radius 114 can equal a multiple or fraction of the maximum radius. In several embodiments, the travel radius 114 can indicate an area of coverage that the distributor nodes 108 can transmit a telecommunication signal.

In a number of embodiments, the travel vector 116 refers to a vector representing a direction of travel of each of the distributor nodes 108. In FIG. 1, the travel vector 116 for each of the distributor nodes 108 is shown as {116a,116b}. In several embodiments, the travel vector 116 can indicate what direction a distributor node (e.g., 108a or 108b) is traveling. The travel vector 116 may be determined in a variety of ways. For example, in several embodiments, the travel vector 116 may be determined by obtaining Global Positioning System (GPS) information and/or coordinates, via a GPS component or third-party mapping service (e.g., Google Maps™, Apple Maps™, etc.) installed on each of the distributor nodes 108 or accessed via an API. In several embodiments, each of the distributor nodes 108 can have its travel vector 116 determined using the GPS coordinates in conjunction with any grid based modeling technique in which the GPS coordinates are used to determine direction of travel or to predict a future position of the distributor nodes 108. The direction of travel or the predicted future position may be determined based on a current position and a trajectory, movement, and/or speed of travel of the distributor nodes 108. In several embodiments, and without limitation, the grid based modeling technique can determine the travel vector 116 by calculating dot products, vector projections, etc., using the GPS coordinates and the trajectory, movement, and/or speed of travel to determine the direction of travel or predicted future position of the distributor nodes 108.

In several embodiments, the travel radius 114 and the travel vector 116 may be used to determine a projected travel path for the distributor nodes 108. The projected travel path refers to a predicted geographic area or geographic areas that the distributor nodes 108 are predicted to reach at some time in the future. In several embodiments, the projected travel path may be determined by analyzing the travel radius 114 and the travel vector 116 for each of the distributor nodes 108 to determine where the distributor nodes 108 will be at a future time. This may be done in a variety of ways. For example, in several embodiments, the projected travel path may be determined by using past or historic positions, paths, routes of travel, or a combination thereof of the distributor nodes 108 to determine the projected travel path. By way of example, in several embodiments, past GPS coordinates of the distributor nodes 108 may be tracked and stored on devices of the system 100 (e.g., the distributor nodes 108 or the server 102), or may be obtained from third-party mapping services (e.g., Google Maps™ Apple Maps™, etc.) via an API. Based on the past GPS coordinates, the projected travel path may be determined to predict where in the future the distributor nodes 108 will likely be. For example, in several embodiments, if a distributor node (e.g., 108b) is traversing a path, as indicated by its travel vector 116b, and the past GPS coordinates indicate that the distributor node 108b historically traverses that path by taking certain streets or roads, a projected travel path may be determined based on these past data points. In several embodiments, machine learning techniques may be utilized to determine the projected travel path or to make predictions, based on past GPS coordinates. For example, the machine learning techniques may be based on Long Short Term Memory (LSTM) or similar machine learning techniques to determine the projected travel path based on past sequences of GPS coordinates.

In several embodiments, the projected travel path can further be determined using information from crowd-sourced information. For example, in several embodiments, information regarding routes or paths taken by other distributor nodes 108, the one or more devices 110, or anonymized third-party devices (obtained from third-party mapping services) may be accumulated and used to determine the projected travel path. For example, popular routes may be determined based on this crowd-sourced information, and popular or heavily traversed paths or routes from these other devices may be used to determine the projected travel path. By way of example, in several embodiments, the server 102 can compare the travel radius 114 and the travel vector 116 of the distributor nodes 108, and compare the information to the same information or historic information of other distributor nodes 108, the one or more devices 110, or anonymized third-party devices that had the same current position and trajectory. In this way, the server 102 can determine the projected travel path by, for example, determining where similarly situated devices traveled to or are travelling to.

In several embodiments, based on the projected travel path, the server 102 can determine whether any distributor devices 108 may be activated to transmit data to the one or more devices 110 in the geographic area 112. For example, in several embodiments, if the server 102 determines that the projected travel path of a distributor node (e.g., 108b) is approaching and will overlap with a geographic area 112 affected by a data transmission problem scenario, the server 102 can select and activate the distributor node 108b to distribute data to the one or more devices 110 within the geographic area 112. In several embodiments, the server 102 can generate a signal or function call to activate the distributor node 108b. The signal or function call can instruct the distributor node 108b to begin distributing data once it enters or has its signal transmission radius overlaps with the geographic area 112. This may be done, for example, by transmitting instructions and GPS coordinates of the geographic area 112, to distributor node 108b instructing that once the distributor node 108b enters the geographic area 112 (based on the GPS coordinates), to activate a peer-to-peer data distribution scheme (e.g., Bluetooth, NFC, etc.) to distribute data to the one or more devices 110.

In several embodiments, the server 102 can also monitor the geographic area 112 to determine whether the triggering event is no longer present or whether the geographic area 112 is no longer a telecommunication dead zone. This may be done by, for example, receiving information from either the monitoring service 106 or determining that the triggering event is no longer present. In several embodiments, if the server 102 determines that the circumstances leading to the triggering event no longer exists, the server 102 can deactivate the distributor nodes 108 from distributing data to the one or more devices 110 within the geographic area. The deactivation, similar to the activation, can take the form of a signal or function call. The signal or function call can deactivate the distributor nodes 108 and instruct the distributor nodes 108 to no longer distribute data within the geographic area 112.

In several embodiments, the system 100 can implement a transaction scheme. The transaction scheme refers to an arrangement in which the system 100 transmits a payment to the distributor nodes 108 based on the distributor nodes 108 distributing data to the one or more devices 110. The payment may be any form of payment, for example and without limitation, a monetary payment, credits, points, etc., that may be transferred to the distributor nodes 108. In several embodiments, the payment may be based on the amount of data the distributor nodes 108 distribute. For example, in several embodiments, the payment may be based on a value per unit of data (e.g., sum of money per megabyte distributed, points per megabyte distributed, etc.). In several embodiments, the payment may be a flat fee per data transmission. The aforementioned are merely exemplary and any transaction model may be employed by an administrator of the system 100. In several embodiments, the server 102 can generate the transaction to the distributor nodes 108 after the distribution is complete or at pre-determined intervals (e.g., every month, once a threshold amount of data is distributed, etc.).

As indicated, in several embodiments, the server 102 can couple to the distributor nodes 108 via the network 104 to distribute data to the one or more devices 110. The network 104 refers to a telecommunications network, such as a wired or wireless network. The network 104 can span and represent a variety of networks and network topologies. For example, the network 104 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 104. Cable, Ethernet, digital subscriber line (DSL), fiber optic lines, fiber to the home (FTTH), and plain old telephone service (POTS) are examples of wired communication that may be included in the network 104. Further, the network 104 can traverse a number of topologies and distances. For example, the network 104 can include a direct connection, personal area network (PAN), local area network (LAN), metropolitan area network (MAN), wide area network (WAN), or a combination thereof. For illustrative purposes, in the embodiment of FIG. 1, the system 100 is shown with the server 102 and the distributor nodes 108 as end points of the network 104. This, however, is exemplary and it is understood that the system 100 can have a different partition between the server 102, the distributor nodes 108, and the network 104. For example, the server 102 and the distributor nodes 108 can also function as part of the network 104.

As indicated, the one or more devices 110 can couple to distributor nodes 108 to receive data from the distributor nodes 108. The one or more devices 110, similar to the distributor nodes 108 may be any of a variety of centralized or decentralized computing devices. In several embodiments, and without limitation, the one or more devices 110 may be a mobile device, a laptop computer, or a desktop computer. The one or more devices 110 can also function as stand-alone devices separate from other devices of the system 100.

In several embodiments, the one or more devices 110 can couple to the distributor nodes 108 via local network protocols and a common application used by both the distributor nodes 108 and the one or more devices 110. The local network protocols refer to wireless protocols that allow peer-to-peer data transmission between devices. Examples of local network protocols include, without limitation, Bluetooth protocols, NFC protocols, WiFi protocols, or similar protocols.

In several embodiments, the common application may be a mobile application that both the distributor nodes 108 and the one or more devices 110 use. In several embodiments, the data distributed by the distributor nodes 108 to the one or more devices 110 may be related to the common application. By way of example, and without limitation, if the common application is a shopping application used to purchase products, the data distributed by the distributor nodes 108 to the one or more devices 110 may be prices for products, coupons, details for products, promotional information, etc.

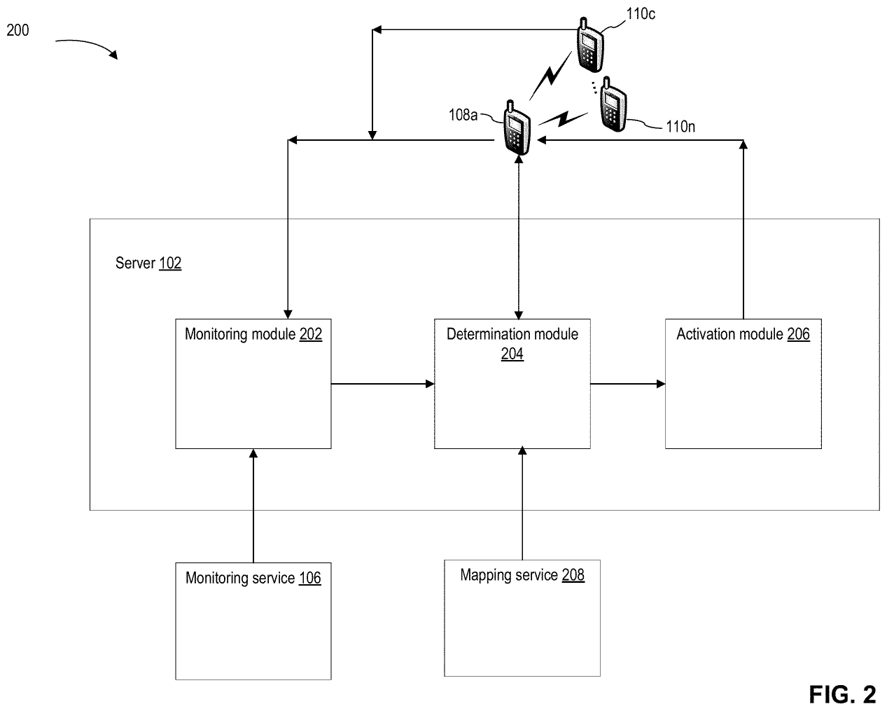

FIG. 2 is an example control flow 200. For example, control flow 200 shows several embodiments of how the system 100 functions. Control flow 200 shows various modules implementing the functionality of the system 100. While control flow 200 shows the modules being implemented on server 102, this is exemplary and for ease of description. In other embodiments, some or all of the modules may be on other devices of the system 100 (e.g., the distributor nodes 108).

In several embodiments, the modules implementing the functionality of the system 100 include a monitoring module 202, a determination module 204, and an activation module 206. In several embodiments, the monitoring module 202 can couple to the determination module 204. The determination module 204 can couple to the activation module 206.

In several embodiments, the monitoring module 202 allows monitoring of the geographic area 112. The monitoring module 202 can implement the functions described with respect to FIG. 1 for monitoring the geographic area 112. For example, in several embodiments, this can include coupling to the monitoring service 106, via an API or otherwise, to determine whether the geographic area 112 is affected by data transmission problem scenarios. In several embodiments, the monitoring module 202 can further detect the triggering event of FIG. 1. For example, the monitoring module 202 can receive information from the distributor nodes 108, the one or more devices 110, servers pushing data to the aforementioned devices, or from other components of the system 100 indicating the triggering event.

In several embodiments, once the monitoring module 202 determines that a geographic area 112 is, or may be, affected by data transmission problem scenarios, the monitoring module 202 can pass control to the determination module 204.

In several embodiments, the determination module 204 can perform several functions. In several embodiments, the determination module 204 can allow determining whether the distributor nodes 108 are approaching the geographic area 112. In several embodiments, this may be done by using the techniques described above with respect to FIG. 1 for determining the projected travel path of distributor nodes 108. In several embodiments, the determination module 204 can further allow selecting the distributor nodes 108 to distribute data. In several embodiments, the selecting may be done, as described in FIG. 1, based on determining that the projected travel path of the distributor nodes 108 will overlap with the geographic area 112 that is, or may be, affected by data transmission problem scenarios. In several embodiments, the determination module 204 can further allow determining whether the distributor node has entered the geographic area. In several embodiments, the determining may be done, as described with respect to FIG. 1, by comparing the GPS coordinates of the distributor nodes 108 to their geographic locations, and determining whether the GPS coordinates indicate that the distributor nodes 108, or their associated travel radius 114 is within the geographic area 112. In several embodiments, in order to perform its functions, the determination module 204 can couple to a mapping service 208. In several embodiments, the mapping service 208 refers to a third-party mapping service that provides GPS coordinates or mapping information that allows the determination module 208 to perform its functions. Examples of the mapping service 208, include without limitation, Google Maps™, Apple Maps™, or other services that GPS coordinates may be obtained from.

In several embodiments, once the determination module 204 performs its functions, the determination module 204 can pass control to the activation module 206. In several embodiments, the activation module 206 can allow activating the distributor nodes 108 to distribute data to the one or more devices within the geographic area 112. In several embodiments, the activation module 206 can perform the activation by generating a signal or function call, as described with respect to FIG. 1, to activate the distributor devices 108.

In several embodiments, the aforementioned control flow 200 may be performed by the modules, units, or services, of the server 102. In several embodiments, some or all of the control flow 200 may be performed by the modules, units, or services of other devices of the system 100, for example the distributor nodes 108.

In several embodiments, the aforementioned modules may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the system 100 and/or installed as a removable portion of the system 100.

In several embodiments, system 100 provides an efficient way to distribute data within geographic areas 112 that are, or may be, affected by data transmission problem scenarios. The efficiency can stem from the use of peer-to-peer data distribution methods to offload data distribution functions to the distributor nodes 108. This offloading can allow for entities (e.g., companies, institutions, governmental agencies, etc.) pushing data to devices (e.g., the one or more devices 110), to distribute data even if geographic areas 112 are affected by data transmission problem scenarios, which would likely not occur otherwise due to the data transmission problem scenarios.

In several embodiments, system 100 can reduce stress on servers entities pushing data to the one or more devices 110, because by offloading data distribution functions to the distributor nodes 108, the servers themselves do not have push data to every single device. This can reduce traffic to and from the servers pushing data, and reduce the processing that needs to be done by the servers.

In several embodiments, the system 100 allows entities that distribute data to the one or more devices 110 to scale their data distribution operations efficiently. Those skilled in the art will recognize that data/content distribution networks are expensive and scaling servers for performance is expensive. The system 100 can allow data distribution to scale without entities having to incur the additional expense of adding servers to obtain greater data distribution footprints. Rather than add servers to increase their data distribution, the system 100 can use existing processing power and data transmission capabilities of the distributor nodes 108 to offload data distribution functions. This can allow entities to achieve the same performance they would gain by adding additional servers, without the additional expense. In addition, the system 100 may at times result in even better data distribution than would be achieved by merely adding servers, because it allows data distribution to the one or more devices 110 in geographic areas 112 that otherwise could have receive data (due to being affected by data transmission problem scenarios).

In several embodiments, the system 100 incentivizes users of devices to become distributor nodes 108. The system 100 does this by implementing a transaction scheme that allows users who opt into being distributor nodes 108 get compensation for becoming distributor nodes 108.

In several embodiments, the system 100 allows entities to stay ahead of potential disruptions in their data distribution operations, by proactively monitoring geographic areas 112 for potential problems. By monitoring geographic areas 112 for data transmission problem scenarios, entities using the system 100 can reactively finding distributor nodes 108 to distribute data to those geographic areas 112, thus avoiding disruptions in their service.

### Methods of Operation

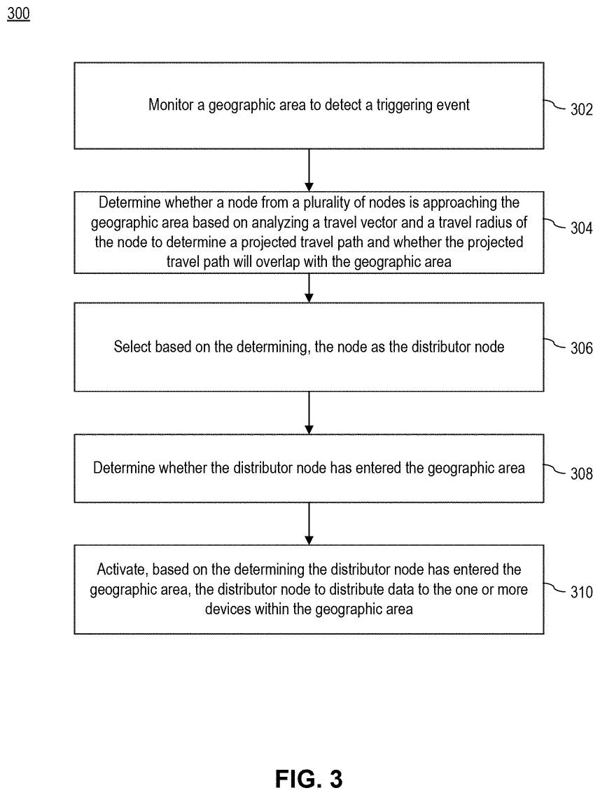

FIG. 3 is an example method 300 according to some embodiments. In some aspects, method 300 can implement system 100 and be implemented by the server 102. It is to be appreciated that the operations may be performed out of order and some operations may not be needed in certain situations.

In step 302, server 102 can monitor a geographic area 112 to detect a triggering event. In several embodiments, the triggering event causes a distributor node (e.g., 108a or 108b) to distribute data to one or more devices 110 within the geographic area 112.

In step 304, server 102 can determine whether a node (e.g., 108a or 108b) from a plurality of nodes (e.g., the distributor nodes 108) is approaching the geographic area 112 based on analyzing a travel vector 116 and a travel radius 114 of the node. The server 102 can further determine a projected travel path and whether the projected travel path will overlap with the geographic area 112.

In step 306, server 102, can select, based on the determining in step 304, the node (e.g., 108a or 108b) as the distributor node (e.g., 108a or 108b).

In step 308, server 102 can determine whether the distributor node (e.g., 108a or 108b) has entered the geographic area 112.

In step 310, server 102 can activate, based on the determining the distributor node (e.g., 108a or 108b) has entered the geographic area 112, the distributor node (e.g., 108a or 108b) to distribute data to the one or more devices 110 within the geographic area 112.

In some embodiments, operation of method 300 is performed, for example, by system 100, in accordance with embodiments described above.

### Components of the System

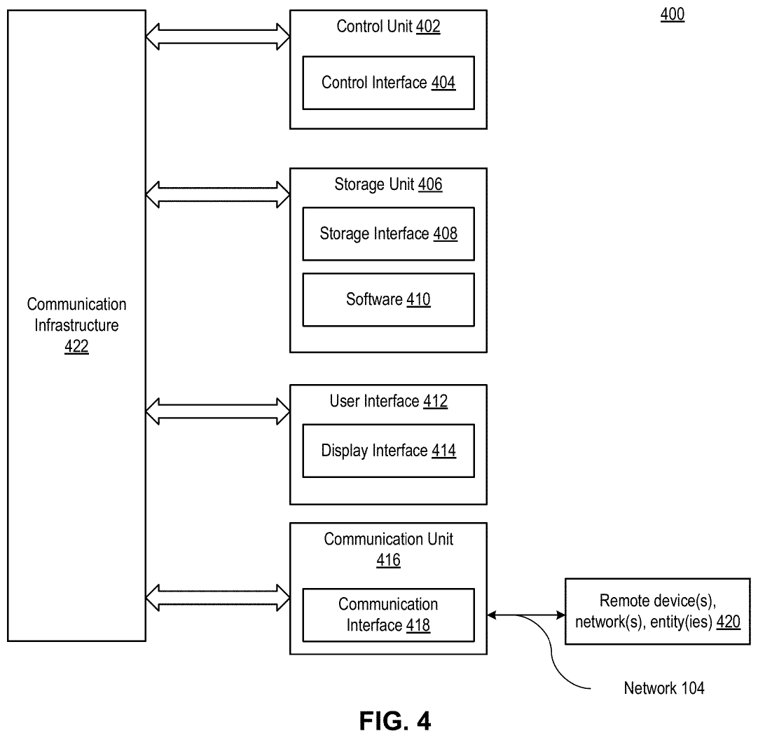

FIG. 4 is an example architecture 400 of devices (e.g., the server 102, the distributor devices 108, or the one or more devices 110) implementing the system 100 according to embodiments. The architecture can include components. In several embodiments, the components may include a control unit 402, a storage unit 406, a communication unit 416, and a user interface 412. The control unit 402 may include a control interface 404. The control unit 402 may execute a software 410 to provide some or all of the intelligence of system 100. The control unit 402 may be implemented in a number of different ways. For example, the control unit 402 may be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The control interface 404 may be used for communication between the control unit 402 and other functional units or devices of system 100. The control interface 404 may also be used for communication that is external to the functional units or devices of system 100. The control interface 404 may receive information from the functional units or devices of system 100, or from remote devices 420, or may transmit information to the functional units or devices of system 100, or to remote devices 420. The remote devices 420 refer to units or devices external to system 100.

The control interface 404 may be implemented in different ways and may include different implementations depending on which functional units or devices of system 100 or remote devices 420 are being interfaced with the control unit 402. For example, the control interface 404 may be implemented with a pressure sensor, an inertial sensor, a microelectromechanical system (MEMS), optical circuitry, waveguides, wireless circuitry, wireline circuitry to attach to a bus, an application programming interface, or a combination thereof. The control interface 404 may be connected to a communication infrastructure 422, such as a bus, to interface with the functional units or devices of system 100 or remote devices 420.

The storage unit 406 may store the software 410. For illustrative purposes, the storage unit 406 is shown as a single element, although it is understood that the storage unit 406 may be a distribution of storage elements. Also for illustrative purposes, the storage unit 406 is shown as a single hierarchy storage system, although it is understood that the storage unit 406 may be in a different configuration. For example, the storage unit 406 may be formed with different storage technologies forming a memory hierarchical system including different levels of caching, main memory, rotating media, or off-line storage. The storage unit 406 may be a volatile memory, a nonvolatile memory, an internal memory, an external memory, or a combination thereof. For example, the storage unit 406 may be a nonvolatile storage such as nonvolatile random access memory (NVRAM), Flash memory, disk storage, or a volatile storage such as static random access memory (SRAM) or dynamic random access memory (DRAM).

The storage unit 406 may include a storage interface 408. The storage interface 408 may be used for communication between the storage unit 406 and other functional units or devices of system 100. The storage interface 408 may also be used for communication that is external to system 100. The storage interface 408 may receive information from the other functional units or devices of system 100 or from remote devices 420, or may transmit information to the other functional units or devices of system 100 or to remote devices 420. The storage interface 408 may include different implementations depending on which functional units or devices of system 100 or remote devices 420 are being interfaced with the storage unit 406. The storage interface 408 may be implemented with technologies and techniques similar to the implementation of the control interface 404.

The communication unit 416 may facilitate communication to devices, components, modules, or units of system 100 or to remote devices 420. For example, the communication unit 416 may permit the system 100 to communicate between the server 102, the distributor nodes 108, the one or more devices 110, the monitoring service 106, and the mapping service 208. The communication unit 416 may further permit the devices of system 100 to communicate with remote devices 420 such as an attachment, a peripheral device, or a combination thereof through the network 104.

As previously indicated, the network 104 may span and represent a variety of networks and network topologies. For example, the network 104 may include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 104. Cable, Ethernet, digital subscriber line (DSL), fiber optic lines, fiber to the home (FTTH), and plain old telephone service (POTS) are examples of wired communication that may be included in the network 104. Further, the network 104 may traverse a number of network topologies and distances. For example, the network 104 may include direct connection, personal area network (PAN), local area network (LAN), metropolitan area network (MAN), wide area network (WAN), or a combination thereof.

The communication unit 416 may also function as a communication hub allowing system 100 to function as part of the network 104 and not be limited to be an end point or terminal unit to the network 104. The communication unit 416 may include active and passive components, such as microelectronics or an antenna, for interaction with the network 104.

The communication unit 416 may include a communication interface 418. The communication interface 418 may be used for communication between the communication unit 416 and other functional units or devices of system 100 or to remote devices 420. The communication interface 418 may receive information from the other functional units or devices of system 100, or from remote devices 420, or may transmit information to the other functional units or devices of the system 100 or to remote devices 420. The communication interface 418 may include different implementations depending on which functional units or devices are being interfaced with the communication unit 416. The communication interface 418 may be implemented with technologies and techniques similar to the implementation of the control interface 404.

The user interface 412 may present information generated by system 100. In several embodiments, the user interface 412 allows a user to interface with the devices of system 100 or remote devices 420. The user interface 412 may include an input device and an output device. Examples of the input device of the user interface 412 may include a keypad, buttons, switches, touchpads, soft-keys, a keyboard, a mouse, or any combination thereof to provide data and communication inputs. Examples of the output device may include a display interface 414. The control unit 402 may operate the user interface 412 to present information generated by system 100. The control unit 402 may also execute the software 410 to present information generated by system 100, or to control other functional units of system 100. The display interface 414 may be any graphical user interface such as a display, a projector, a video screen, or any combination thereof.

The above detailed description and embodiments of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting method 300 and system 100 are cost-effective, highly versatile, and accurate, and may be implemented by adapting components for ready, efficient, and economical manufacturing, application, and utilization. Another important aspect of embodiments of the present disclosure is that it valuably supports and services the historical trend of reducing costs, simplifying systems, and/or increasing performance.

These and other valuable aspects of the embodiments of the present disclosure consequently further the state of the technology to at least the next level. While the disclosed embodiments have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the scope of the invention should be determined not by the embodiments illustrated, but by the appended claims and their equivalents.

What is claimed is:

1. A computer implemented method for distributing data, the method comprising:
monitoring, by one or more computing devices, a geographic area to detect a triggering event, wherein the triggering event causes a distributor node to distribute data to one or more devices within the geographic area;
determining, by the one or more computing devices, whether a node from a plurality of nodes is approaching the geographic area based on analyzing a travel vector and a travel radius of the node to determine a projected travel path and whether the projected travel path will overlap with the geographic area;
selecting, by the one or more computing devices and based on the determining, the node as the distributor node;
determining, by the one or more computing devices, whether the distributor node has entered the geographic area; and
activating, by the one or more computing devices and based on the determining the distributor node has entered the geographic area, the distributor node to distribute data to the one or more devices within the geographic area.

2. The method of claim 1, further comprising analyzing, by the one or more computing devices, a travel history of the node to determine the projected travel path.

3. The method of claim 1, further comprising detecting the triggering event by detecting a telecommunication dead zone.

4. The method of claim 1, further comprising detecting the triggering event by detecting that a number of the one or more devices within the geographic area has reached a threshold value.

5. The method of claim 1, further comprising:
detecting the triggering event by detecting an increase or decrease of data requests from the geographic area,
wherein the increase or decrease is determined by comparing a current volume of data requests in the geographic area to a historic average of data requests for the geographic area.

6. The method of claim 1, further comprising:
determining, by the one or more computing devices, that the triggering event no longer exists; and
deactivating, by the one or more computing devices and based on the determining that the triggering event no longer exists, the distributor node from distributing data to the one or more devices within the geographic area.

7. The method of claim 1, further comprising:
generating, by the one or more computing devices, a transaction to the distributor node based on distributing the data; and
transmitting, by the one or more computing devices, the transaction to the distributor node.

8. A non-transitory computer readable medium including instructions for causing a processor to perform operations for distributing data, the operations comprising:
monitoring, by one or more computing devices, a geographic area to detect a triggering event, wherein the triggering event causes a distributor node to distribute data to one or more devices within the geographic area;
determining, by the one or more computing devices, whether a node from a plurality of nodes is approaching the geographic area based on analyzing a travel vector and a travel radius of the node to determine a projected travel path and whether the projected travel path will overlap with the geographic area;
selecting, by the one or more computing devices and based on the determining, the node as the distributor node;
determining, by the one or more computing devices, whether the distributor node has entered the geographic area;
activating, by the one or more computing devices and based on the determining the distributor node has entered the geographic area, the distributor node to distribute data to the one or more devices within the geographic area; and
analyzing, by the one or more computing devices, a travel history of the node to determine the projected travel path.

9. The non-transitory computer readable medium of claim 8, wherein the operations further comprise detecting the triggering event by detecting a telecommunication dead zone.

10. The non-transitory computer readable medium of claim 8, wherein the operations further comprise detecting the triggering event by detecting that a number of the one or more devices within the geographic area has reached a threshold value.

11. The non-transitory computer readable medium of claim 8, wherein the operations further comprise:
detecting the triggering event by detecting an increase or decrease of data requests from the geographic area,
wherein the increase or decrease is determined by comparing a current volume of data requests in the geographic area to a historic average of data requests for the geographic area.

12. The non-transitory computer readable medium of claim 8, wherein the operations further comprise:
determining, by the one or more computing devices, that the triggering event no longer exists; and
deactivating, by the one or more computing devices and based on the determining that the triggering event no longer exists, the distributor node from distributing data to the one or more devices within the geographic area.

13. The non-transitory computer readable medium of claim 8, wherein the operations further comprise:
generating, by the one or more computing devices, a transaction to the distributor node based on distributing the data; and
transmitting, by the one or more computing devices, the transaction to the distributor node.

14. A system for distributing data comprising:
a storage unit configured to store instructions; and
a control unit, coupled to the storage unit, configured to process the stored instructions to:
monitor a geographic area to detect a triggering event, wherein the triggering event causes a distributor node to distribute data to one or more devices within the geographic area, determine whether a node from a plurality of nodes is approaching the geographic area based on analyzing a travel vector and a travel radius of the node to determine a projected travel path and whether the projected travel path will overlap with the geographic area,
select, based on the determining, the node as the distributor node,
determine whether the distributor node has entered the geographic area, and
activate, based on the determining the distributor node has entered the geographic area, the distributor node to distribute data to the one or more devices within the geographic area.

15. The system of claim 14, wherein the control unit is further configured to analyze a travel history of the node to determine the projected travel path.

16. The system of claim 14, wherein the control unit is further configured to detect the triggering event by detecting a telecommunication dead zone.

17. The system of claim 14, wherein the control unit is further configured to detect the triggering event by detecting that a number of the one or more devices within the geographic area has reached a threshold value.

18. The system of claim 14, wherein the control unit is further configured to:
detect an increase or decrease of data requests from the geographic area,
wherein the increase or decrease is determined by comparing a current volume of data requests in the geographic area to a historic average of data requests for the geographic area.

19. The system of claim 14, wherein the control unit is further configured to:
determine that the triggering event no longer exists; and
deactivate, based on the determining that the triggering event no longer exists, the distributor node from distributing data to the one or more devices within the geographic area.

20. The system of claim 14, wherein:
the control unit is further configured to generate a transaction to the distributor node based on distributing the data; and
the system further comprises a communication unit, coupled to the storage unit, configured to process the stored instructions to transmit the transaction to the distributor node.
